(19) United States
(12) Patent Application Publication
(10) Pub. No.: US 2016/0369427 A1
(43) Pub. Date: Dec. 22, 2016

(54) HORIZONTAL HEAT TREATMENT APPARATUS AND CARBON FIBER PRODUCTION METHOD USING HORIZONTAL HEAT TREATMENT APPARATUS

(71) Applicant: MITSUBISHI RAYON CO., LTD., Chiyoda-ku (JP)

(72) Inventors: Keishi MIZUNO, Otake-shi (JP); Youji HATANAKA, Otake-shi (JP); Hitoshi TOMOBE, Otake-shi (JP); Yusuke OKA, Otake-shi (JP)

(73) Assignee: MITSUBISHI RAYON CO., LTD., Chiyoda-ku (JP)

(21) Appl. No.: 14/901,864

(22) PCT Filed: Jul. 1, 2014
(86) PCT No.: PCT/JP2014/067571

§ 371 Date: Dec. 29, 2015

(30) Foreign Application Priority Data
Jul. 2, 2013 (JP) 2013-138614

(51) Int. Cl. D01F 9/32; F27D 99/00; F27D 7/06; F27B 9/28

(52) U.S. Cl. CPC D01F 9/328; F27B 9/28; F27D 99/0073; F27D 99/007; F27D 7/06; D10B 2101/12

(57) ABSTRACT

The present invention is: a horizontal heat treatment apparatus for continuously heat-treating by moving a continuous flat workpiece to be treated (carbon-fiber-precursor fiber bundles) back and forth in the horizontal direction on multiple levels inside a heat treatment chamber, the horizontal heat treatment apparatus being characterized by being provided with a sealing chamber (4) which is continuous from the entrance (6) side of the heat treatment chamber (2) in to which the workpiece to be treated is conveyed to the exit (6′) side thereof and that is vertically delimited by partition plates making a heat transfer zone in which 2 to 4 levels of the workpiece are transferred, among which the temperature of the workpiece transferred in a lower level is higher than the temperature of the workpiece transferred in a higher level. As a result, the horizontal heat treatment apparatus completely prevents leakage of poisonous gas produced in the heat treatment chamber, and effectively prevents energy loss.

### TECHNICAL FIELD

The present invention relates to a horizontal heat treatment apparatus which completely suppresses a poisonous gas produced inside a heat treatment chamber from leaking to external air and improves energy efficiency and a carbon fiber production method which uses the horizontal heat treatment apparatus.

The present invention relates to a horizontal heat treatment apparatus which continuously performs a heat treatment on a continuous flat workpiece such as a fiber sheet and a carbon fiber production method which uses the horizontal heat treatment apparatus, and more particularly, to a heat treatment apparatus which is appropriately used in a flame proofing furnace that performs a heat treatment on a carbon-fiber precursor fiber bundle when a carbon fiber is produced.

### BACKGROUND ART

Hitherto, there is known a heat treatment apparatus which continuously performs a heat treatment on a workpiece when an elongated material such as a film, a sheet, and a fiber (hereinafter, referred to as a workpiece) is produced. In the case of an example of a carbon fiber, the heat treatment apparatus is used to continuously perform a heat treatment on, for example, a carbon-fiber precursor fiber bundle formed of a poly acrylonitrile fiber inside a heat treatment chamber. At this time, a pyrolysis gas such as cyanide, ammonia, and carbon oxide is produced inside the heat treatment chamber due to an oxidization reaction of the carbon-fiber precursor fiber bundle. The pyrolysis gas needs to be collected and subjected to a gas treatment such as a combustion process.

Due to the oxidization reaction of the flame proofing treatment, a pyrolysis gas such as cyanide, ammonia, and carbon oxide is produced inside the heat treatment chamber. Furthermore, in a case where the workpiece is conveyed into and out from the heat treatment chamber, an entrance and an exit for the workpiece are essentially provided in the heat treatment apparatus. Further, a sealing chamber for close guard is provided so that the gas inside the heat treatment chamber does not leak from the entrance and the exit to the outside of the furnace.

Patent Document 1 discloses a heat treatment apparatus in which a sealing chamber is defined in the vertical direction by a partition plate and one exhaust port is provided in each of the defined sealing chambers so as to adjust the pressure of each sealing chamber. For that reason, the heat treatment apparatus is able to separately control a pressure difference between the inside of a heat treatment chamber and the inside of the sealing chamber, is able to control external air flowing into the heat treatment chamber or hot air excessively flowing from the heat treatment chamber due to an influence of a difference in buoyant force inside and outside the heat treatment chamber, and has an excellent uniform temperature.

Patent Document 2 discloses a heat treatment apparatus in which a sealing chamber is defined by a partition plate. For that reason, the heat treatment apparatus is able to appropriately adjust the pressure of each sealing chamber, is able to separately control a pressure difference between the inside of a heat treatment chamber and the inside of the sealing chamber, is able to control external air flowing into the heat treatment chamber or hot air excessively flowing out from the heat treatment chamber due to an influence of a difference in buoyant force inside and outside the heat treatment chamber, and has an excellent uniform temperature.

Patent Document 3 discloses a heat treatment apparatus which prevents a pyrolysis gas from leaking from an entrance/the exit of a workpiece in the heat treatment apparatus to the outside of the heat treatment apparatus. Here, a sealing chamber is provided near a heat treatment chamber so that a negative pressure is formed therein and a pyrolysis gas is collected, and an air curtain unit is provided at the outside of an entrance/an exit of the workpiece in the sealing chamber so that air outside the heat treatment apparatus is ejected toward the workpiece and external air is suppressed from flowing thereinto.

As a method of solving an uneven temperature and degradation in energy efficiency of a heat treatment furnace caused by external air flowing thereinto, Patent Document 4 discloses a heat treatment apparatus in which a sealing chamber is provided so that a horizontal slit-shaped opening portion through which a workpiece is conveyed is provided in a plurality of stages in the up and down direction of an outer side wall. Here, the heat treatment apparatus includes a gas ejection port which supplies a gas toward the upper or lower portion of the sealing chamber in the same direction as the direction of a heated gas of a heat treatment chamber and a gas suction port which suctions a gas in a direction facing the gas ejection port.

### CITATION LIST

### Patent Document

Patent Document 1: JP 2007-132657 A

Patent Document 2: JP 62-228866 A

Patent Document 3: JP 2004-143647 A

Patent Document 4: JP 2010-100967 A

### DISCLOSURE OF THE INVENTION

### Problem to be Solved by the Invention

An objective of the present invention is to completely suppress the poisonous gas produced inside the heat treatment chamber from leaking to external air and to efficiently perform a heat exchange in the workpieces.

As disclosed in Patent Document 4, when hot air is ejected in a direction orthogonal to the traveling direction of the workpiece, a large-scale facility is needed in order to prevent a gas from leaking to the outside of the furnace while ensuring the control of the temperature inside the heat treatment chamber.

The present invention is made to solve the above-described problems, and an objective of the present invention is to provide a horizontal heat treatment apparatus capable of decreasing unevenness in temperature inside a heat treatment chamber, ensuring stability in process, and improving uniformity in quality by increasing the temperature of a workpiece conveyed to the heat treatment chamber while efficiently performing a heat exchange in the workpieces and completely suppressing a poisonous gas produced inside the heat treatment chamber from leaking to external air without particularly demanding a large-scale facility and to provide a carbon fiber production method using the horizontal heat treatment apparatus.

### Means for Solving Problem

According to an aspect of the present invention, provided is a horizontal heat treatment apparatus that continuously performs a heat treatment on a continuous flat workpiece while moving the continuous flat workpiece in a reciprocating manner through a heat treatment chamber in a plurality of stages in the horizontal direction, wherein the following conditions (1) to (3) are satisfied: (1) the heat treatment chamber has sealing chambers which are connected to an entrance and an exit of the workpiece; (2) one or more partition plates having the workpiece traveling in the horizontal direction in both of the upper and lower sides are disposed inside the sealing chamber and zones defined in the vertical direction is formed by two partition plates or one partition plate and an inner wall of the sealing chamber; and (3) the partition plate is disposed so as to satisfy the following conditions (a) and (b): (a) the zones include one or more heat transfer zones in which the workpiece being conveyed into the heat treatment chamber is located higher in relation to the workpiece being conveyed out from the heat treatment chamber; and (b) one or more steps in which the workpiece firstly passes through one of the heat transfer zones inside one sealing chamber, secondly travels through inside of the heat treatment chamber, and thirdly passes through one of the heat transfer zones inside the other sealing chamber are included.

It is desirable that the number of the heat transfer zones in the condition (a) be 10% or more of the number of all zones inside the sealing chambers. Then, it is desirable that the number of times of causing the workpiece to travel through inside of the heat treatment chamber in the steps defined in the condition (b) be 10% or more of the number of times of causing the workpiece to travel through inside of the heat treatment chamber.

Further, it is desirable that the number of times of causing the workpiece to travel through each of the heat transfer zones defined in the condition (a) in a reciprocating manner be two to four. Then, it is more desirable that the number of times of causing the workpiece to travel through each of the heat transfer zones in the condition (a) be two and the number of times of causing the workpiece to travel through each of the zones inside the sealing chamber be three or less.

At least one exhaust mechanism can be provided in each zone.

Further, an air curtain mechanism or a slit-shaped nozzle can be provided so as to eject air from each zone toward a heat treatment apparatus entrance through which the workpiece is conveyed from the outside of the heat treatment apparatus into each zone and a heat treatment apparatus exit through which the workpiece is conveyed out from each zone to the outside of the heat treatment apparatus.

The horizontal heat treatment apparatus can be used as a flame proofing furnace that performs a heat treatment on a carbon-fiber precursor fiber bundle.

According to another aspect of the present invention, provided is a carbon fiber bundle production method of obtaining a carbon fiber bundle by continuously performing a heat treatment on a continuous flat carbon-fiber precursor fiber bundle while moving the continuous flat carbon-fiber precursor fiber bundle in a reciprocating manner through a heat treatment chamber in a plurality of stages in the horizontal direction, wherein sealing chambers are provided so as to be connected to an entrance and an exit of the carbon-fiber precursor fiber bundle into and out of the heat treatment chamber, wherein one or more partition plates are disposed so as to have the carbon-fiber precursor fiber bundle in both of the upper and lower sides and zones are defined in the vertical direction by two partition plates or one partition plate and an inner wall of the sealing chamber so that the carbon-fiber precursor fiber bundle traveling through the sealing chamber satisfies the following conditions (c) and (d): (c) the zone includes one or more heat transfer zones in which the carbon-fiber precursor fiber bundle being conveyed into the heat treatment chamber is located higher in relation to the carbon-fiber precursor fiber bundle being conveyed out from the heat treatment chamber; and (d) one or more steps in which the carbon-fiber precursor fiber bundle firstly passes through one of the heat transfer zones inside one sealing chamber, secondly travels through inside of the heat treatment chamber, and thirdly passes through one of the heat transfer zones inside the other sealing chamber are included.

It is desirable that the number of the heat transfer zones in the condition (c) be 10% or more of the number of all zones inside the sealing chambers and the number of times of causing the carbon-fiber precursor fiber bundle to travel through inside of the heat treatment chamber in the steps defined in the condition (d) be 10% or more of the number of times of causing the carbon-fiber precursor fiber bundle to travel through inside of the heat treatment chamber.

It is desirable that the number of times of causing the carbon-fiber precursor fiber bundle to travel through each of the heat transfer zones defined in the condition (c) in a reciprocating manner be two to four. Then, it is desirable that the number of times of causing the carbon-fiber precursor fiber bundle to travel through each of the heat transfer zones defined in the condition (c) be two and the number of times of causing the carbon-fiber precursor fiber bundle to travel through each of the zones inside the sealing chambers be three or less.

In the sealing chamber, zones are defined in the vertical direction by two partition plates or one partition plate and an inner wall of the sealing chamber. In the zones, the heat radiated from the relatively high-temperature workpiece conveyed from the heat treatment chamber to the outside of the heat treatment apparatus is transferred to the relatively low-temperature workpiece conveyed from the outside of the heat treatment apparatus into the heat treatment chamber. For this reason, a heat exchange is performed by a temperature gradient in the up and down direction. Here, the heat exchange indicates a phenomenon where the temperature of the low-temperature workpiece increases by the heat radiated from the high-temperature workpiece inside a certain heat transfer zone.

In the horizontal heat treatment apparatus and the carbon fiber bundle production method of the present invention, the convection is used. Further, a heat transfer zone (a) is formed in the zones in which the workpiece at the entrance to the heat treatment chamber is located higher in relation to the workpiece at the exit from the heat treatment chamber (a zone in which the workpiece at the entrance to the heat treatment chamber is located higher in relation to the workpiece at the exit from the heat treatment chamber will be referred to as a “heat transfer zone (a)” below). Accordingly, a heat exchange in the workpieces is more efficiently performed.

Further, in the present invention, it is desirable to employ a step in which the workpiece firstly passes through the heat transfer zone (a) inside one sealing chamber, secondly travels through the heat treatment chamber, and thirdly passes through the heat transfer zone (a) inside the other sealing chamber.

Since the each sealing chamber is provided with the heat transfer zone(s) (a) and the workpiece continuously passes through both heat transfer zones (a), the efficient heat exchange can be performed. Further, since the temperature of the workpiece conveyed from each sealing chamber to the outside of the horizontal heat treatment apparatus decreases compared to the related art, it is possible to suppress an increase in temperature of the working space around the horizontal heat treatment apparatus. Further, since the temperature of the workpiece conveyed from each sealing chamber into the heat treatment chamber increases compared to the related art, it is possible to decrease unevenness in temperature inside the heat treatment chamber. Further, since it is possible to suppress unevenness in temperature of the structure material of the heat treatment furnace and/or the sealing chamber, it is possible to prevent the damage of the apparatus caused by the thermal strain and to prevent the yarn sheet as the workpiece from contacting the apparatus at the bottom of its catenary.

In the present invention, it is desirable to provide the partition plate so that the number of the heat transfer zones (a) is 10% or more of the number of all zones included in the sealing chambers. When the ratio is 10% or more, the heat exchange effect is sufficiently exhibited. Here, 35% or more is more desirable, 45% or more is further desirable, and 70% or more is particularly desirable. Here, 100% is the most desirable.

In the present invention, it is desirable to provide the partition plate so that the number of times of causing the workpiece to travel through the heat treatment chamber while satisfying the configuration (b) is 10% or more of the total number of times of causing the workpiece to travel through the heat treatment chamber. Since the ratio is 10% or more, the heat exchange effect is sufficiently exhibited. Further, the temperature of the working space around the horizontal heat treatment apparatus can be decreased and unevenness in temperature of the structure material of the heat treatment furnace and/or the sealing chamber can be suppressed. Here, 50% or more is more desirable and 65% or more is further desirable. Here, 100% is the most desirable.

In the present invention, it is desirable that the number of times of causing the workpiece to travel through each of the heat transfer zones (a) in a reciprocating manner be two to four. When the number of times of causing the workpiece to travel in a reciprocating manner is once, the configuration of the heat transfer zone (a) cannot be realized. Then, when the number of times of causing the workpiece to travel in a reciprocating manner is five or more, it is difficult to control external air flowing into the heat treatment chamber or hot air excessively flowing from the heat treatment chamber due to an influence of a difference in buoyant force inside and outside the heat treatment chamber. It is desirable that the number of times of causing the workpiece to travel be two or three. Here, two is the most desirable.

Further, as for the number of times of causing the workpiece to travel through each of the zones in a reciprocating manner, three or less is desirable in consideration of the external air flowing into the heat treatment chamber or the hot air flowing out from the heat treatment chamber.

Further, as for an exhaust adjustment mechanism, generally, the rotation speed of the exhaust fan is adjusted by the comparing the internal pressure of the sealing chamber and the internal pressure of the heat treatment chamber. However, for the automation thereof, a detector detecting a change in internal pressure and a control unit adjusting the displacement of the exhaust mechanism by the detected signal from the detector may be provided.

Generally, a pressure difference between the pressure inside the heat treatment chamber and the pressure outside the heat treatment chamber changes in the height direction of the heat treatment chamber due to an influence of a difference in buoyant force inside and outside the heat treatment chamber caused by a difference in gas temperature. That is, the pressure difference inside and outside the heat treatment chamber is large at the upper portion of the heat treatment chamber, and the pressure difference inside and outside the heat treatment chamber is small at the lower portion of the heat treatment chamber.

For that reason, in the horizontal heat treatment apparatus without the sealing chamber in the related art, the hot air inside the heat treatment chamber easily leaks from the exit of the fiber sheet formed at the upper portion of the heat treatment chamber, and the external air easily flows into the heat treatment chamber from the exit of the fiber sheet formed at the lower portion of the heat treatment chamber. However, since the heat treatment chamber of the present invention with the above-described configuration includes the sealing chambers, it is possible to further decrease the pressure inside the sealing chamber compared to the pressure of the heat treatment chamber. For this reason, the external air can be prevented from flowing into the heat treatment chamber having a difference in pressure in the vertical direction inside the heat treatment chamber and thus the unevenness in temperature inside the heat treatment chamber can be extremely reduced.

Further, since the sealing chamber is defined in the vertical direction by the partition plates, each of the defined zones can be provided with at least one exhaust port, and each exhaust port includes the exhaust mechanism and the exhaust adjustment mechanism, it is possible to independently set the exhaust velocity in each zone and to appropriately adjust the pressure of each zone. For that reason, it is possible to individually control the difference of the pressure inside the heat treatment chamber from the pressure inside of each of the zones and hence to control external air flowing into the heat treatment chamber or hot air excessively flowing from the heat treatment chamber due to an influence of a difference in buoyant force inside and outside the heat treatment chamber.

Furthermore, generally, when the exhaust velocity from the exhaust port is large, the outward leakage of the gas inside the heat treatment chamber can be prevented. However, the amount of heat discharged from the inside of the heat treatment chamber also increases. Accordingly, the temperature inside the heat treatment chamber easily decreases, and this is not desirable for the control of the temperature. Further, the amount of the gas subjected to the combustion treatment also increases.

Therefore, it is desirable to adjust and maintain the exhaust velocity from the exhaust ports so that the internal pressure of the heat treatment chamber is lower than the internal pressure of the sealing chamber.

### Effect of the Invention

According to the present invention, it is possible to provide the horizontal heat treatment apparatus capable of ensuring stability in process, decreasing equipment cost, and excellently saving energy while completely suppressing a poisonous gas produced inside a heat treatment chamber from leaking to external air and efficiently performing a heat exchange in workpieces and to provide a carbon fiber production method using the horizontal heat treatment apparatus.

Since the heat exchange is efficiently performed in the workpieces in each sealing chamber, the temperature of the workpiece conveyed from each sealing chamber to the heat treatment chamber increases compared to the related art, and hence unevenness in temperature inside the heat treatment chamber can be reduced. Further, since the temperature of the workpiece conveyed from each sealing chamber to the outside of the horizontal heat treatment apparatus decreases compared to the related art, it is possible to lower the ambient atmosphere temperature and the poisonous gas concentration and hence to ensure a clean environment in the working space.

### BRIEF DESCRIPTION OF DRAWINGS

FIG. 1 is a schematic cross-sectional view illustrating an embodiment of a horizontal heat treatment apparatus of the present invention;

FIG. 2 is a schematic cross-sectional view illustrating the vicinity of a sealing chamber of a heat transfer zone (a) of the horizontal heat treatment apparatus of Example 1 of the present invention;

FIG. 3 is a schematic cross-sectional view illustrating the vicinity of a sealing chamber of an embodiment of a heat transfer zone (a) of the horizontal heat treatment apparatus of the present invention; and

FIG. 4 is a schematic cross-sectional view illustrating a horizontal heat treatment apparatus of a comparative example 1 of the invention.

### MODE(S) FOR CARRYING OUT THE INVENTION

Hereinafter, an embodiment of a horizontal heat treatment apparatus of the present invention will be described in detail with reference to the drawings. Here, an example will be described in which a horizontal flame proofing furnace is the horizontal heat treatment apparatus.

Furthermore, in the specification, the “upstream” and the “downstream” respectively indicate the upstream and the downstream of the workpiece conveying direction.

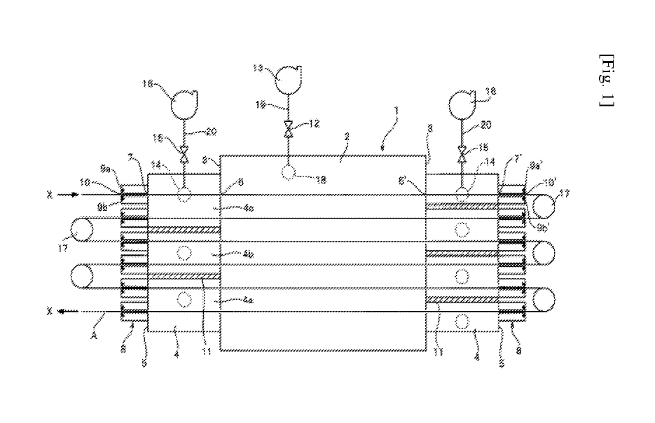

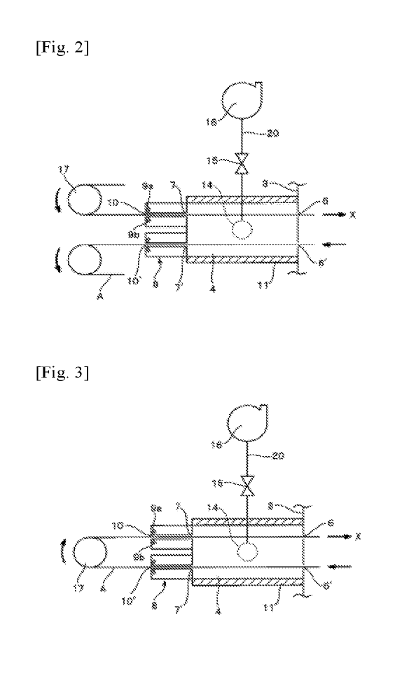

As shown in FIG. 1, a horizontal heat treatment apparatus (a horizontal flame proofing furnace) 1 includes a heat treatment chamber 2 and a sealing chamber 4 connected to the heat treatment chamber 2. A structure is employed in which a workpiece A travels through the sealing chamber 4 (the upstream side), the heat treatment chamber 2, and the sealing chamber 4 (the downstream side) in a reciprocating manner as a plurality of stages.

The horizontal heat treatment apparatus 1 includes a box-shaped heat treatment chamber 2. A heater and a hot air circulation device (not shown) circulating hot air inside the heat treatment chamber 2 are connected to the inside of the heat treatment chamber 2. By the hot air, the workpiece A can be heated for a heat treatment. As an example of a carbon fiber production, the horizontal heat treatment apparatus 1 is used to continuously perform a heat treatment on a carbon-fiber precursor fiber bundle formed of poly acrylonitrile fibers inside the heat treatment chamber 2. In this case, pyrolysis gases such as cyanide, ammonia, and carbon oxide are generated inside the heat treatment chamber due to an oxidization reaction of the precursor fiber. There is a need to collect and dispose the pyrolysis gas by, for example, a combustion treatment thereon.

The heat treatment chamber 2 is provided with an exhaust port 18. The exhaust port 18 is connected to an exhaust fan 13 through an exhaust line 19. For example, a flow rate adjustment mechanism 12 such as a valve is provided in the course of the exhaust line 19. The exhaust fan 13 is connected to an external gas collection/disposal device (not shown).

The sealing chambers 4 are connected on outer walls (two opposite side walls) 3 at the upstream side and the downstream side (both left and right sides of the drawing) of the heat treatment chamber 2. Here, the sealing chambers have a negative pressure therein and collect a pyrolysis gas in order to prevent the pyrolysis gas produced in a furnace from leaking to the outside of the horizontal heat treatment apparatus 1 from a horizontal heat treatment apparatus entrance 10 and a horizontal heat treatment apparatus entrance exit 10′ for the workpiece A of the horizontal heat treatment apparatus 1. The sealing chamber 4 can be formed in a box shape.

The outer walls 5 (the upstream side wall of the upstream box-shaped sealing chamber 4 and the downstream side wall of the downstream box-shaped sealing chamber 4) of the sealing chamber 4 are provided with slit-shaped openings (a sealing chamber outer wall entrance 7 as an opening for the entrance of the workpiece A to the sealing chamber 4 and a sealing chamber outer wall exit 7′ as an opening for the exit of the workpiece A from the sealing chamber 4) where the workpiece A, for example, a carbon-fiber precursor fiber bundle formed as a poly acrylonitrile fiber bundle enters and exits. Similarly, the heat treatment chamber outer wall 3 is also provided with a heat treatment chamber outer wall entrance 6 and a heat treatment chamber outer wall exit 6′ respectively corresponding to the sealing chamber outer wall entrance 7 and the sealing chamber outer wall exit 7′.

That is, the sealing chambers 4 and 4 are respectively provided at the workpiece entrance (the heat treatment chamber outer wall entrance 6) of the heat treatment chamber 2 and the workpiece exit (the heat treatment chamber outer wall exit 6′) thereof.

As the workpiece A, a long sheet-shaped material having a width in the depth direction of the drawing can be used. When the workpiece A is the carbon-fiber precursor fiber bundle, the precursor fibers are arranged in the depth direction of the drawing and are evenly arranged in a sheet shape on the whole. Then, the sheet-shaped material can be supplied to the horizontal heat treatment apparatus 1.

Partition plates 11 are provided inside the sealing chamber 4 so as to define the sealing chamber 4 into three different zones 4a, 4b, and 4c in the vertical direction. Further, the sealing chamber 4 includes an exhaust port 14, and is connected to an exhaust fan 16 through an exhaust line 20. For example, a flow rate adjustment mechanism 15 such as a valve is provided in the course of the exhaust line 20. The exhaust port 14 is provided in each of the zones 4a, 4b, and 4c.

It is desirable to define the sealing chamber 4 by the partition plates 11 so that the entrance of the workpiece A to the heat treatment chamber 2 is located higher and the exit of the workpiece from the heat treatment chamber 2 is located lower than each other in that the heat exchange efficiency of the workpieces A can be further improved.

A pair of slit-shaped nozzles is provided so as to eject air from the sealing chambers 4 toward the horizontal heat treatment apparatus entrance 10 through which the workpiece A is conveyed from the outside of the horizontal heat treatment apparatus 1 into each of the sealing chambers 4 defined by the partition plates 11 in the vertical direction and the horizontal heat treatment apparatus exit 10′ through which the workpiece A is conveyed from the sealing chamber 4 toward the outside of the horizontal heat treatment apparatus 1. Specifically, in order to suppress the flow rate of the external air flowing from the outside of the horizontal heat treatment apparatus 1 into the sealing chamber 4, a pair of slit-shaped entrance side air curtain nozzles 9a and 9b (nozzles of an air curtain unit) is provided at the upper and lower positions interposing the workpiece A so as to eject air toward the center of the passage in the up and down direction and the opening of the horizontal heat treatment apparatus entrance 10. Further, in order to suppress the flow rate of the external air flowing from the outside of the horizontal heat treatment apparatus 1 into the sealing chamber 4, a pair of slit-shaped exit side air curtain nozzles 9a′ and 9b′ (nozzles of an air curtain unit) is provided so as to eject air toward the center of the passage in the up and down direction and the opening of the horizontal heat treatment apparatus exit 10′.

Next, the effect of the embodiment will be described.

As shown in FIG. 1, in a state where the workpieces A are evenly arranged in a direction perpendicular to the drawing paper, the workpieces are conveyed from the uppermost horizontal heat treatment apparatus entrance 10 of the left sealing chamber 4 of the horizontal heat treatment apparatus 1 in the drawing into the horizontal heat treatment apparatus 1 (particularly, the entrance side air curtain unit 8). Subsequently, the workpieces A are conveyed through the sealing chamber outer wall entrance 7 of the outer wall 5 of the sealing chamber 4 and the heat treatment chamber outer wall entrance 6 of the outer wall 3 of the heat treatment chamber 2 and are conveyed out from the heat treatment chamber outer wall exit 6′ of the opposite outer wall 3 of the heat treatment chamber 2. Further, the workpieces A are conveyed through the sealing chamber outer wall exit 7′ of the outer wall 5 of the sealing chamber 4 connected to the heat treatment chamber 2, are conveyed through the air curtain unit 8 (the exit side), and are conveyed to the outside of the horizontal heat treatment apparatus 1. The workpieces A which are conveyed to the outside of the horizontal heat treatment apparatus 1 are folded back so as to be wound on a roll 17 provided outside the horizontal heat treatment apparatus 1 and are conveyed from one lower entrance of the sealing chamber outer wall exit 7′ into the horizontal heat treatment apparatus 1 again.

Each workpiece A which is conveyed into the horizontal heat treatment apparatus 1 again is conveyed to the outside of the horizontal heat treatment apparatus 1 while passing through the same path in the opposite direction and is folded back while being wound on the roll 17 outside the horizontal heat treatment apparatus 1. In this way, the workpiece A passes through the horizontal heat treatment apparatus 1 in a meandering manner while being repeatedly folded back outside the horizontal heat treatment apparatus 1 by the roll 17 and repeatedly being conveyed into and out from the horizontal heat treatment apparatus 1. At this time, driving force which is generated by the powered rotation of the roll 17 and the friction of the surface of the roll 17 is applied to the workpiece A, and the workpiece is continuously conveyed out in the direction of the arrow X of FIG. 1.

At this time, it is desirable that the workpieces A pass through the sealing chamber 4 while staying therein for 6 seconds or more. The staying time is calculated from the conveying speed (m/s) of the workpiece A and the length (m) of the sealing chamber 4.

Meanwhile, hot air is circulated inside the heat treatment chamber 2 by a hot air circulation device (not shown) and is maintained at, for example, the temperature of 200° C. to 300° C. Thus, the workpiece A which is continuously and repeatedly conveyed into the heat treatment chamber 2 is gradually subjected to the heat treatment inside the heat treatment chamber 2. At this time, a pyrolysis gas such as cyanide, ammonia, and carbon oxide is produced inside the heat treatment chamber 2 due to the oxidization reaction of the workpiece A. The gas inside the heat treatment chamber 2 is discharged by the exhaust fan 13 and is collected by the external gas collection/disposal device so as to be disposed. Further, the amount of the produced pyrolysis gas to be discharged from the exhaust port 18 provided in the heat treatment chamber 2 can be adjusted by, for example, the flow rate adjustment mechanism 12 such as a valve.

Further, a negative pressure is formed inside the sealing chamber 4 in a manner such that a gas therein is suctioned by the exhaust fan 16. Further, a pressure distribution is formed inside the heat treatment chamber 2 by the heating so that the upside has a high pressure and the downside has a low pressure. Here, the pressure inside each of the zones 4a, 4b, and 4c of the sealing chamber 4 is adjusted to a pressure in which the amount of the gas introduced from the sealing chamber 4 into the heat treatment chamber 2 or the amount of the gas discharged from the heat treatment chamber 2 into the sealing chamber 4 becomes minimal in response to the pressure distribution inside the heat treatment chamber 2 in the up and down direction and the discharge of the gas from the sealing chamber outer wall entrance 7 and the sealing chamber outer wall exit 7′ into the external sealing chambers 4 and 4 can be prevented.

Further, in order to suppress the external air from flowing into the sealing chambers 4 and 4 each having a negative pressure, the air outside the horizontal heat treatment apparatus 1 is supplied to the air curtain unit 8 and the air is ejected from the entrance side air curtain nozzles 9a and 9b and the exit side air curtain nozzles 9a′ and 9b′ toward the outside of the sealing chamber 4 and the workpiece A so as to form an air curtain. Air is ejected from the entrance side air curtain nozzle 9a and 9b toward the horizontal heat treatment apparatus entrance 10. Further, air is ejected from the exit side air curtain nozzle 9a′ and 9b′ toward the horizontal heat treatment apparatus exit 10′.

It is desirable to adjust the exhaust velocity and the ejection amount of the air curtain nozzle in response to the internal pressure of the sealing chamber 4 and to suppress external air from flowing into the sealing chamber outer wall entrance 7 and the sealing chamber outer wall exit 7′ so that the external air flowing speed Vo decreases to 0.2 m/s or less.

Hereinafter, the invention will be described in more detail by an example.

By the horizontal heat treatment apparatus 1 such as shown in FIG. 1, a flame proofing treatment was performed on a yarn sheet obtained by binding 50,000 PAN single filaments each having a thickness of 1.33 dtex and used as the workpiece A on the condition that the length of the sealing chamber 4 in the traveling direction of the workpiece A was 1.5 m and the traveling speed of the workpiece A traveling through the horizontal heat treatment apparatus 1 was 12 m/min.

The horizontal heat treatment apparatus 1 was controlled so that the distance between the stages, that is, the distance of the workpiece A at the entrance and the exit was 200 mm and the inside of the heat treatment chamber 2 was heated by an electric heater provided in a circulation path so that the temperature became 250° C.

Further, each evaluation method below was used for each measurement.

[Temperature of Workpiece Conveyed from Sealing Device]

The temperature of the workpiece conveyed out from the sealing device at a position separated from the sealing chamber outer wall exit by about 100 mm was measured by an infrared thermometer (IT-550L manufactured by HORIBA, Ltd.) in a direction from the folding roll. Further, as for the plurality of workpieces conveyed out from the sealing device and existing within the each zone, an average value of the measurement values of the workpieces was calculated.

[Temperature of Workpiece Conveyed into Heat Treatment Furnace]

By using a thermocouple (EXE-K-3 manufactured by Okazaki Manufacturing Company), the temperature of the workpiece conveyed into the heat treatment furnace at a position separated from the heat treatment chamber outer wall entrance by about 100 mm in the heat treatment chamber was measured. Further, as for the plurality of workpieces conveyed into the heat treatment furnace and existing within the each zone, an average value of the measurement values of the workpieces was calculated.

[External Air Flowing Speed]

Since it was difficult to directly measure an external air flowing speed Vo, the pressure inside the air curtain was measured by a fine pressure difference meter (DP-5 A manufactured by Okano Works, Ltd.).

[Heat Treatment Furnace Power]

The heater power was measured from the output of the electric heater provided in the heat treatment furnace.

[Existence of Leakage to External Air]

Regarding the gas flowing from the sealing chamber outer wall entrance 7 into the sealing chamber 4 or the gas flowing from the sealing chamber 4 through the sealing chamber outer wall entrance 7, the leakage was measured by a smoke tester manufactured by Gastec Corporation at a position in the vicinity of the sealing chamber outer wall exit provided in the sealing device. The smoke flow direction was observed. When the smoke was suctioned from the vicinity of the sealing chamber outer wall exit into the sealing chamber 4, an evaluation of “OK” was given. Meanwhile, when the smoke leaked from the vicinity of the sealing chamber outer wall exit toward the external air, an evaluation of “NG” was given.

[Thermal Strain Status]

In operation, the dimensions of the sealing device and the folding roll were measured with a tape measure. When no difference in dimension between the opposite sealing chambers was observed, an evaluation of “non-existence of strain” was given. Further, when a difference of 1 to 5 mm was observed, an evaluation of “existence of slight strain” was given. Furthermore, when a difference of 6 mm or more was observed, an evaluation of “existence of strain” was given.

Furthermore, in the example and the comparative example below, the “sealing device exit workpiece temperature” indicates the temperature of the workpiece A conveyed from the heat treatment chamber 2 into each sealing chamber 4, conveyed out from the sealing chamber 4 to the outside of the horizontal heat treatment apparatus 1, and located at the sealing chamber outer wall exit 7′, and the “heat treatment furnace entrance workpiece temperature” indicates the temperature of the workpiece A conveyed from the outside of the horizontal heat treatment apparatus 1 into each sealing chamber 4, conveyed from each sealing chamber 4 to the heat treatment chamber 2, and located at the heat treatment chamber outer wall entrance 6.

### Example 1

The inside of the sealing chamber 4 was defined by the partition plates 11 so that the number of all zones was eight and the number of the heat transfer zones (a) therein was six. In each of the heat transfer zones (a), traveling of the workpiece A in the horizontal direction was defined every two stages, and was defined every stage in the zones other than the heat transfer zones (a).

In this example, the ratio of the number of the heat transfer zones (a) with respect to the number of all zones was 75%. The number of times of steps in which the workpiece A firstly passes through the heat transfer zone (a) inside one sealing chamber 4, secondly travels inside the heat treatment chamber 2, and thirdly passes through the heat transfer zone (a) inside the other sealing chamber 4 was four, and the ratio with respect to the number of all traveling operations was 57%.

After the adjustment of the air curtain unit 8 and the exhaust mechanism provided in each heat transfer zone (a), the workpiece A was subjected to the heat treatment in the heat treatment furnace with the above-described configuration. Compared to Comparative Example 1 below, the sealing device exit workpiece temperature was decreased by 7.7° C. and the heat treatment chamber entrance workpiece temperature was increased by 4.6° C. From this result, it was found that the heater power was decreased by 18 kW. Further, the leakage status was checked by the smoke tester. Then, it was found that no leakage was found and a satisfactory sealing operation was performed. Further, it was also found that a production was performed stably with a negligible strain in operation. The external air flowing speed Vo of 0.2 m/s was obtained.

### Example 2

The inside of the sealing chamber 4 was defined by the partition plates 11 so that the number of all zones was four and the number of the heat transfer zones (a) therein was three. In each of the heat transfer zones (a), traveling of the workpiece A in the horizontal direction was defined every four stages, and was defined every stage in the zones other than the heat transfer zones (a).

In this case, the ratio of the number of the heat transfer zones (a) with respect to the number of all zones was 75%. The number of times of steps in which the workpiece A firstly passes through the heat transfer zone (a) inside one sealing chamber 4, secondly travels inside the heat treatment chamber 2, and thirdly passes through the heat transfer zone (a) inside the other sealing chamber 4 was four, and the ratio with respect to the number of all traveling operations was 57%.

After the adjustment of the air curtain unit 8 and the exhaust mechanism provided in each heat transfer zone (a), the workpiece A was subjected to the heat treatment in the heat treatment furnace with the above-described configuration.

The measurement was performed similarly to Example 1. Compared to Comparative Example 1 below, the sealing device exit workpiece temperature was decreased by 5.5° C. and the heat treatment chamber entrance workpiece temperature was increased by 4.0° C. From this result, it was found that the heater power was decreased by 13 kW. Further, the leakage status was checked by the smoke tester. Then, it was found that no leakage was found and the external air flowing speed Vo was 0.2 to 0.25 m/s. Further, it was also found that a production was performed stably with a negligible strain in operation.

### Example 3

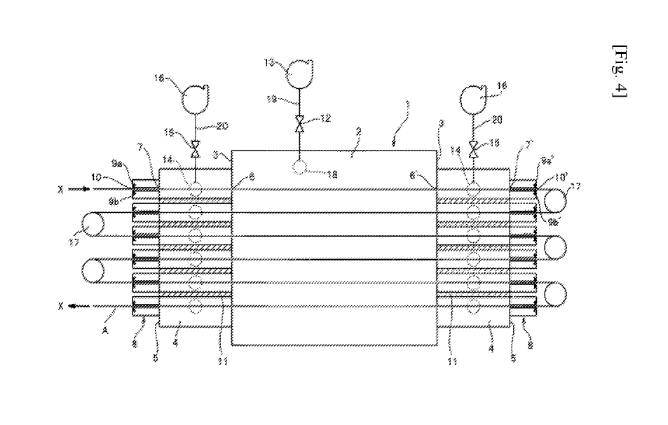

The inside of the sealing chamber 4 was defined by the partition plates 11 so that the number of all zones was eight and the number of the heat transfer zones (a) therein was two. As shown in FIG. 3, in each of the heat transfer zones (a), traveling of the workpiece A in the horizontal direction was defined every two stages, and was defined every stage in the zones other than the heat transfer zones (a).

In this example, a ratio of the number of the heat transfer zones (a) with respect to the number of all zones was 13%. The number of times of steps in which the workpiece A firstly passes through the heat transfer zone (a) inside one sealing chamber 4, secondly travels inside the heat treatment chamber 2, and thirdly passes through the heat transfer zone (a) inside the other sealing chamber 4 was one, and the ratio with respect to the number of all traveling operations was 14%.

The measurement was performed similarly to Example 1. Compared to Comparative Example 1 below, in the heat transfer zone (a), the sealing device exit workpiece temperature was decreased by 7.7° C. and the heat treatment chamber entrance workpiece temperature was increased by 4.6° C. From this result, it was found that the heater power was decreased by 2 kW. Further, the leakage status was checked by the smoke tester. Then, it was found that no leakage was found and the external air flowing speed Vo was 0.2 m/s. Further, it was also found that a production was performed stably with a negligible strain in operation.

### Example 4

The inside of the sealing chamber 4 was defined by the partition plates 11 so that the number of all zones was eight and the number of the heat transfer zones (a) therein was four. In each of the heat transfer zones (a), traveling of the workpiece A in the horizontal direction was defined every two stages, and was defined every stage in the zones other than the heat transfer zones (a).

In this example, the ratio of the number of the heat transfer zones (a) with respect to the number of all zones was 50%. The number of times of steps in which the workpiece A firstly passes through the heat transfer zone (a) inside one sealing chamber 4, secondly travels inside the heat treatment chamber 2, and thirdly passes through the heat transfer zone (a) inside the opposite sealing chamber 4 was one, and the ratio with respect to the number of all traveling operations was 14%.

The workpiece A was subjected to the heat treatment in the heat treatment furnace with the above-described configuration. Compared to Comparative Example 1 below, in the heat transfer zone (a), the sealing device exit workpiece temperature was decreased by 7.7° C. and the heat treatment chamber entrance workpiece temperature was increased by 4.6° C. From this result, it was found that the heater power was decreased by 12 kW. Further, the leakage status was checked by the smoke tester. Then, it was found that no leakage was found and a sealing operation was performed. Further, the strain status was checked. As a result, a slight strain not causing any problem in operation was found.

### Comparative Example 1

The measurement was performed similarly to Example 1 except that the inside of the sealing chamber 4 was defined by the partition plates into every stage of the workpiece A as shown in FIG. 4. The sealing device exit workpiece temperature and the heat treatment furnace entrance workpiece temperature measured by the comparative example were used as reference values. The leakage status was checked by the smoke tester. As a result, no leakage was found.

### Example 5

The inside of the sealing chamber 4 was defined by the partition plates 11 so that the number of all zones was four and the number of the heat transfer zones (a) therein was two. In the heat transfer zones (a), traveling of the workpiece A in the horizontal direction was defined every five stages, and was defined every stage in the zones other than the heat transfer zones (a).

In this example, the ratio of the number of the heat transfer zones (a) with respect to the number of all zones was 50%. The number of times of steps in which the workpiece A firstly passes through the heat transfer zone (a) inside one sealing chamber 4, secondly travels inside the heat treatment chamber 2, and thirdly passes through the heat transfer zone (a) inside the other sealing chamber 4 was five, and the ratio with respect to the number of all traveling operations was 71%.

The workpiece A was subjected to the heat treatment in the heat treatment furnace with the above-described configuration. Compared to Comparative Example 1, in the heat transfer zone (a), the sealing device exit workpiece temperature was decreased by 3.5° C. and the heat treatment chamber entrance workpiece temperature was increased by 3.3° C. From this result, it was found that the heater power was decreased by 6.0 kW.

Further, the leakage status was checked by the smoke tester. As a result, a leakage from a part of the sealing chamber outer wall entrance 7 was found and hence a sealing operation was not performed completely.

In Examples 1 to 3, such an ejection was not found. Here, a gas was ejected from a part inside the furnace, and the gas of the sealing chamber 4 leaked from the sealing chamber outer wall entrance 7 to the outside of the horizontal heat treatment apparatus 1. Further, it was also found that a production was performed stably with a negligible strain in operation.

### Example 6

The measurement was performed similarly to Example 1 except that the exhaust mechanism was not provided in the heat transfer zone (a).

Compared to Comparative Example 1, in the heat transfer zone (a), the sealing device exit workpiece temperature was decreased by 7.7° C. and the heat treatment chamber entrance workpiece temperature was increased by 4.6° C. From this result, it was found that the heater power was decreased by 18 kW. Further, it was also found that a production was performed stably with a negligible strain in operation. However, since the exhaust mechanism was not provided, the leakage of the gas inside the furnace couldn't be suppressed.

### Example 7

The measurement was performed similarly to Example 1 except that the air curtain unit 8 was not provided.

Compared to Comparative Example 1, in the heat transfer zone (a), the sealing device exit workpiece temperature was decreased by 7.7° C. and the heat treatment chamber entrance workpiece temperature was increased by 4.6° C. From this result, it was found that the heater power was decreased by 18 kW. Further, it was also found that a production was performed stably with a negligible strain in operation. However, since the exhaust mechanism was not provided, the leakage of the gas inside the furnace couldn't be suppressed.

### Example 8

The inside of the sealing chamber 4 was defined by the partition plates 11 so that the number of all zones was eight and the number of the heat transfer zones (a) therein was two.

The heat transfer zones (a) are provided in only one sealing chamber 4. Here, in each of the heat transfer zones (a), traveling of the workpiece A in the horizontal direction was defined every two stages, and in the zones other than the heat transfer zones (a), the workpiece was defined every stage.

In this example, the ratio of the number of the heat transfer zones (a) with respect to the number of all zones was 38%. The number of times of steps in which the workpiece A firstly passes through the heat transfer zone (a) inside one sealing chamber 4, secondly travels inside the heat treatment chamber 2, and thirdly passes through the heat transfer zone (a) inside the opposite sealing chamber 4 was zero, and a ratio with respect to the number of all traveling operations was 0%.

The workpiece A was subjected to the heat treatment in the heat treatment furnace with the above-described configuration. Compared to Comparative Example 1, in the heat transfer zone (a), the sealing device exit workpiece temperature was decreased by 7.7° C. and the heat treatment chamber entrance workpiece temperature was increased by 4.6° C. From this result, it was found that the heater power was decreased by 18 kW. Further, the leakage status was checked by the smoke tester, and no leakage was found. Further, the strain status was checked. As a result, a slight strain not causing any problem in operation was found.

All the result of Examples 1 to 8 and Comparative Example 1 is shown in Table 1.

From this result, when the sealing chamber 4 is defined every two stages (Examples 1, 3, and 4) and every four stages (Example 2), the “sealing device exit workpiece temperature” is decreased, the “heat treatment furnace entrance workpiece temperature” is increased, the “external air flowing speed” is substantially uniform, or the “leakage to the external air” is not observed compared to the case where the sealing chamber is defined every stage (Comparative Example 1). Accordingly, it is understood that the heat exchange between the workpieces A in the sealing chambers 4 is efficiently performed.

From the comparison of Examples 1 to 8, it is understood that the heat exchange efficiency of the workpieces A in the sealing chambers 4 is satisfactory in the case where the sealing chamber is defined every two stages (Example 1) compared to the case where the sealing chamber is defined every four stages (Example 2) and the heat exchange is more efficiently performed when the ratio of the heat transfer zone (a) with respect to all zones is larger even in the case of every two stages.

TABLE 1

| | | | | | Compar- | | | | |
|---|---|---|---|---|---|---|---|---|---|
| | Exam- | Exam- | Exam- | Exam- | ative | Exam- | Exam- | Exam- | Exam- |
| | ple 1 | ple 2 | ple 3 | ple 4 | Example 1 | ple 5 | ple 6 | ple 7 | ple 8 |
| Sealing chamber zone | Every | Every | Every | Every | Each | Every | Every | Every | Every |
| | two | four | two | two | stage | five | two | two | two |
| | stages | stages | stages | stages | | stages | stages | stages | stages |
| Number of all zones (x) | 8 | 4 | 8 | 8 | 14 | 4 | 8 | 8 | 8 |
| Number of heat transfer zones (a) | 6 | 3 | 2 | 4 | 0 | 2 | 6 | 6 | 2 |
| Total number of times of travel (y) | 7 | 7 | 7 | 7 | 7 | 7 | 7 | 7 | 7 |
| Number of heat transfer zones satisfying | 6 | 3 | 2 | 4 | 0 | 2 | 6 | 6 | 3 |
| condition (a): heat transfer zones (a) | | | | | | | | | |
| Number of times of travel while satisfying the | 4 | 4 | 1 | 1 | 0 | 5 | 4 | 4 | 0 |
| condition (b): number of times of travel (b) | | | | | | | | | |
| Ratio of heat transfer zones (a) to number | 75% | 75% | 13% | 50% | 0% | 50% | 75% | 75% | 38% |
| of all zones (x) | | | | | | | | | |
| Ratio of number of times of travel (b) to | 57% | 57% | 14% | 14% | 0% | 71% | 57% | 57% | 0% |
| total number of times of travel (y) | | | | | | | | | |
| Number of times of travel in heat transfer zone | 2 times | 4 times | 2 times | 2 times | 0 time | 6 times | 2 times | 2 times | 2 times |
| Exhaust mechanism | Pro- | Pro- | Pro- | Pro- | Pro- | Pro- | Not | Pro- | Pro- |
| | vided | vided | vided | vided | vided | vided | provided | vided | vided |
| Air curtain device | Pro- | Pro- | Pro- | Pro- | Pro- | Pro- | Pro- | Not | Pro- |
| | vided | vided | vided | vided | vided | vided | vided | provided | vided |
| Sealing device exit workpiece temperature | 7.7↓ | 5.5↓ | 7.7↓ | 7.7↓ | Standard | 3.5↓ | 7.7↓ | 7.7↓ | 7.7↓ |
| [° C.] | | | | | | | | | |
| Heat treatment furnace entrance workpiece | 4.6↑ | 4.0↑ | 4.6↑ | 4.6↑ | Standard | 3.3↑ | 4.6↑ | 4.6↑ | 4.6↑ |
| temperature [° C.] | | | | | | | | | |
| External air flowing speed [m/s] | 0.2 | 0.2 to 0.25 | — | — | 0.2 | — | — | — | — |
| Leakage of gas in furnace to the external air | OK | OK | OK | OK | OK | NG | NG | NG | NG |
| Decreased amount of heat treatment furnace | 18↓ | 13.0↓ | 2.0↓ | 12↓ | Standard | 6.0↓ | 18↓ | 18↓ | 8.0↓ |
| power [kW] | | | | | | | | | |
| Thermal strain status | No strain | No strain | No strain | Slight | No strain | No strain | No strain | No strain | Strain |
| | | | | strain | | | | | |

### EXPLANATIONS OF LETTERS OR NUMERALS

1: horizontal heat treatment apparatus (horizontal flame proofing furnace)
2: heat treatment chamber
3: heat treatment chamber outer wall
4: sealing chamber
4a, 4b, 4c: zones of sealing chamber
5: outer wall of sealing chamber
6: heat treatment chamber outer wall entrance
6′: heat treatment chamber outer wall exit
7: sealing chamber outer wall entrance
7′: sealing chamber outer wall exit
8: air curtain unit
9a, 9b: entrance side air curtain nozzle (upside and downside)
9a′, 9b′: exit side air curtain nozzle (upside and downside)
10: horizontal heat treatment apparatus entrance
10′: horizontal heat treatment apparatus exit
11: partition plate
12: flow rate adjustment mechanism
13: exhaust fan
14: exhaust port
15: flow rate adjustment mechanism
16: exhaust fan
17: roll
18: exhaust port
19: exhaust line
20: exhaust line
A: workpiece
X: workpiece conveying direction

1. A horizontal heat treatment apparatus that continuously performs a heat treatment on a continuous flat workpiece while moving the continuous flat workpiece in a reciprocating manner through a heat treatment chamber in a plurality of stages in the horizontal direction,
wherein the following conditions (1) to (3) are satisfied:
(1) the heat treatment chamber has sealing chambers which are connected to an entrance and an exit of the workpiece;
(2) one or more partition plates having the workpiece traveling in the horizontal direction in both of the upper and lower sides are disposed inside the sealing chamber and zones defined in the vertical direction are formed by two partition plates or by one partition plate and an inner wall of the sealing chamber; and
(3) the partition plate is disposed so as to satisfy the following conditions (a) and (b):
(a) the zones include one or more heat transfer zones in which the workpiece being conveyed into the heat treatment chamber is located higher in relation to the workpiece being conveyed out from the heat treatment chamber; and
(b) one or more steps in which the workpiece firstly passes through one of the heat transfer zones inside one sealing chamber, secondly travels through inside of the heat treatment chamber, and thirdly passes through one of the heat transfer zones inside the other sealing chamber are included.

2. The horizontal heat treatment apparatus according to claim 1,
wherein the number of the heat transfer zones in the condition (a) is 10% or more of the number of all zones inside the sealing chambers.

3. The horizontal heat treatment apparatus according to claim 1,
wherein the number of times of causing the workpiece to travel through inside of the heat treatment chamber in the steps defined in the condition (b) is 10% or more of the number of times of causing the workpiece to travel through inside of the heat treatment chamber.

4. The horizontal heat treatment apparatus according to claim 1,
wherein the number of times of causing the workpiece to travel through each of the heat transfer zones defined in the condition (a) in a reciprocating manner is two to four.

5. The horizontal heat treatment apparatus according to claim 1,
wherein the number of times of causing the workpiece to travel through each of the heat transfer zones defined in the condition (a) is two, and the number of times of causing the workpiece to travel through each of the zones inside the sealing chamber is three or less.

6. The horizontal heat treatment apparatus according to claim 1,
wherein the heat treatment chamber is provided with sealing chambers connected to the heat treatment chamber at an entrance and an exit of the workpiece, and
wherein the sealing chamber formed of zones which are defined by a partition plate every two to four stages in the horizontal direction where the workpiece travels.

7. The horizontal heat treatment apparatus according to claim 1,
wherein at least one of the zones is formed as a heat transfer zone in which the entrance of the workpiece to the heat treatment chamber is located in the higher side and the exit of the workpiece from the heat treatment chamber is located in the lower side.

8. The horizontal heat treatment apparatus according to claim 1,
wherein each zone is provided with at least one exhaust mechanism.

9. The horizontal heat treatment apparatus according to claim 1,
wherein an air curtain mechanism or a slit-shaped nozzle is provided so as to eject air from each zone toward a heat treatment apparatus entrance through which the workpiece is conveyed from the outside of the heat treatment apparatus into each zone and a heat treatment apparatus exit through which the workpiece is conveyed out from each zone to the outside of the heat treatment apparatus.

10. The horizontal heat treatment apparatus according to claim 1,
wherein the horizontal heat treatment apparatus is used as a flame proofing furnace that performs a heat treatment on a carbon-fiber precursor fiber bundle.

11. A carbon fiber production method comprising:
a step of continuously performing a heat treatment on a carbon-fiber precursor fiber bundle by using the horizontal heat treatment apparatus according to claim 1.

12. A carbon fiber production method of obtaining a carbon fiber by continuously performing a heat treatment on a continuous flat carbon-fiber precursor fiber bundle while moving the continuous flat carbon-fiber precursor fiber bundle in a reciprocating manner through a heat treatment chamber in a plurality of stages in the horizontal direction,
wherein sealing chambers are provided so as to be connected to an entrance and an exit of the carbon-fiber precursor fiber bundle into and out of the heat treatment chamber,
wherein one or more partition plates are disposed so as to have the carbon-fiber precursor fiber bundle in both of the upper and lower sides and zones are defined in the vertical direction by two partition plates or one partition plate and an inner wall of the sealing chamber so that the carbon-fiber precursor fiber bundle traveling through the sealing chamber satisfies the following conditions (c) and (d):
(c) the zone includes one or more heat transfer zones in which the carbon-fiber precursor fiber bundle being conveyed into the heat treatment chamber is located higher in relation to the carbon-fiber precursor fiber bundle being conveyed out from the heat treatment chamber; and
(d) one or more steps in which the carbon-fiber precursor fiber bundle firstly passes through one of the heat transfer zones inside one sealing chamber, secondly travels through inside of the heat treatment chamber, and thirdly passes through one of the heat transfer zones inside the other sealing chamber are included.

13. The carbon fiber production method according to claim 12,
wherein the number of the heat transfer zones in the condition (c) is 10% or more of the number of all zones inside the sealing chambers.

14. The carbon fiber production method according to claim 12,
wherein the number of times of causing the carbon-fiber precursor fiber bundle to travel through inside of the heat treatment chamber in the steps defined in the condition (d) is 10% or more of the number of times of causing the carbon-fiber precursor fiber bundle to travel through inside of the heat treatment chamber.

15. The carbon fiber production method according to claim 12,
wherein the number of times of causing the carbon-fiber precursor fiber bundle to travel through each of the heat transfer zones defined in the condition (c) in a reciprocating manner is two to four.

16. The carbon fiber production method according to claim 12,
wherein the number of times of causing the carbon-fiber precursor fiber bundle to travel through each of the heat transfer zones defined in the condition (c) is two, and the number of times of causing the carbon-fiber precursor fiber bundle to travel through each of the zones inside the sealing chambers is three or less.
